(19) United States
(12) Patent Application Publication
(10) Pub. No.: US 2018/0278681 A1
(43) Pub. Date: Sep. 27, 2018

(54) INFORMATION PROCESSING DEVICE, INFORMATION PROCESSING SYSTEM, AND INFORMATION PROCESSING METHOD

(71) Applicant: FUJITSU LIMITED, Kawasaki-shi (JP)

(72) Inventors: YUICHI HANADA, Kawasaki (JP); Akira FUJII, Machida (JP)

(73) Assignee: FUJITSU LIMITED, Kawasaki-shi (JP)

(21) Appl. No.: 15/921,806

(22) Filed: Mar. 15, 2018

(30) Foreign Application Priority Data
Mar. 22, 2017 (JP) 2017-055843

(51) Int. Cl. H04L 29/08; H04W 84/20

(52) U.S. Cl. CPC H04L 67/1051; H04W 8/005; H04W 84/20

(57) ABSTRACT

There is provided an information processing device that is a first information processing device, the information processing device including a memory, and a processor coupled to the memory and the processor configured to transmit, to a second information processing device, a first beacon for indicating that the first information processing device operates as a gateway, receive a second beacon for requesting that the first information processing device transmits data included in the second beacon to a server, and transmit, to the server, the data included in the second beacon and a source identification of the second beacon.

### CROSS-REFERENCE TO RELATED APPLICATION

This application is based upon and claims the benefit of priority of the prior Japanese Patent Application No. 2017-055843, filed on Mar. 22, 2017, the entire contents of which are incorporated herein by reference.

### FIELD

The embodiments discussed herein are related to an information processing device, an information processing system, and an information processing method.

### BACKGROUND

In recent years, a participatory sports watching using, for example, smartphones has attracted attention. For example, when a spectator watching a game at a stadium waves a smartphone instead of a flag, the support contents corresponding to the number of times of waving are displayed on a large-sized vision. In this case, the data indicating the number of times of waving of the smartphone by the spectator is transmitted from the smartphone to a server.

Here, in a place where people are densely populated, such as a stadium, when data is transmitted from each smartphone to the server, the processing load of the server and the traffic volume of a network increase. Thus, a technique is known in which a gateway collects data from each smartphone and transmits the collected data to the server.

A technique is also known in which one device is selected from plural devices, and the selected device serves as a gateway to transmit data collected from other devices to the server.

Related techniques are disclosed in, for example, Japanese Laid-Open Patent Publication Nos. 2016-116194 and 2013-050824.

### SUMMARY

According to an aspect of the invention, an information processing device that is a first information processing device, the information processing device includes a memory, and a processor coupled to the memory and the processor configured to transmit, to a second information processing device, a first beacon for indicating that the first information processing device operates as a gateway, receive a second beacon for requesting that the first information processing device transmits data included in the second beacon to a server, and transmit, to the server, the data included in the second beacon and a source identification of the second beacon.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of the overall configuration of a data collection system according to an embodiment;

FIG. 2 is a view for explaining the outline of data collection and GW determination;

FIG. 3 is a view illustrating an example of the hardware configuration of a terminal device according to an embodiment;

FIG. 4 is a view illustrating an example of the functional configuration of a terminal device according to an embodiment;

FIG. 5 is a view illustrating an example of service information;

FIG. 6 is a view illustrating an example of a GW list;

FIG. 7 is a flowchart illustrating an example of the overall processing of a terminal device according to an embodiment;

FIG. 8 is a flowchart illustrating an example of out-of-service time processing according to an embodiment;

FIG. 9 is a flowchart illustrating an example of service processing according to an embodiment;

FIG. 10 is a flowchart illustrating an example of beacon processing according to an embodiment; and

FIG. 11 is a flowchart illustrating an example of transmission processing of a GW notification beacon or a transmission request beacon according to an embodiment.

### DESCRIPTION OF EMBODIMENTS

In the related art, a device serving as a gateway may concentrate on a specific device. For this reason, the processing load on the specific device may increase.

For example, in a case of determining a smartphone to be a gateway depending on the remaining battery capacity, there is a case where the smartphone serving as the gateway concentrates on a smartphone with a relatively larger remaining battery capacity. In this case, the processing load on a specific smartphone having the larger remaining battery capacity may increase.

Hereinafter, embodiments of a technique capable of effectively performing addition and distribution will be described with reference to the accompanying drawings.

[Overall Configuration of Data Collection System]

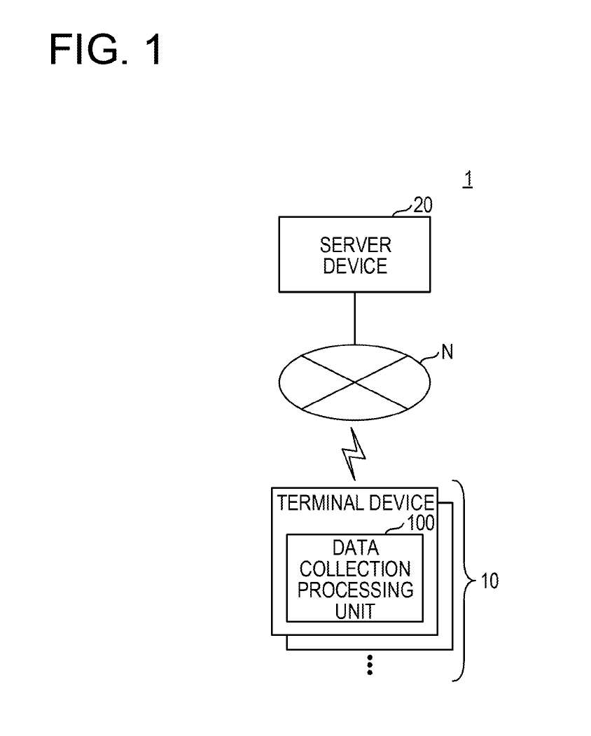

First, the overall configuration of a data collection system 1 according to an embodiment will be described with reference to FIG. 1. FIG. 1 is a view illustrating an example of the overall configuration of a data collection system 1 according to this embodiment.

As illustrated in FIG. 1, the data collection system 1 according to the present embodiment includes one or more terminal devices 10 and a server device 20. The terminal devices 10 and the server device 20 are communicably connected via a network N such as the Internet.

Each terminal device 10 is, for example, an information processing device such as a smartphone, a tablet terminal, or a mobile phone. The terminal device 10 may be, for example, a laptop personal computer (PC), a personal digital assistant (PDA), or a wearable terminal.

The terminal device 10 includes a data collection processing unit 100. The terminal device 10 collects data from the other terminal devices 10 by means of the data collection processing unit 100 and transmits the collected data to the server device 20. That is, when the terminal device 10 satisfies a predetermined condition, the data collection processing unit 100 causes the terminal device 10 to function as a gateway (GW) and collects data from the other terminal devices 10. Then, the data collection processing unit 100 transmits the collected data to the server device 20. Hereinafter, the “gateway” is also simply referred to as “GW.”

At this time, the data collection system 1 according to the present embodiment determines a terminal device 10 that is to function as the GW next, among the plural terminal devices 10 that satisfy the predetermined condition (that is, the condition for GW), so that the terminal device 10 functioning as the GW does not concentrate on one terminal device 10.

Thereby, it is possible to prevent the processing load of the server device 20 and the traffic amount of the network N from increasing, and it is also possible to distribute the processing load among the plural terminal devices 10.

Examples of the condition for GW (hereinafter, referred to as “GW condition”) may include the condition for the number of times of waving of the terminal device 10 (that is, the number of times of vibration of the terminal device 10), and the condition for the number of times of tapping of a touch panel of the terminal device 10.

The server device 20 is one or more information processing devices that provide a predetermined service based on data transmitted from the terminal device 10.

For example, the service provided by the server device 20 may include, in a case where the data transmitted from the terminal device 10 is data indicating the number of times of waving of the terminal device 10 by stadium audience, a service to display the support contents corresponding to the total number of times of waving on a large-scale vision of the stadium. In addition, the service provided by the server device 20 may include, in a case where the data transmitted from the terminal device 10 is voice data indicating a cheer of stadium audience, a service to display the contents indicated by the voice data on a public viewing monitor.

In this manner, the server device 20 provides a predetermined service based on the predetermined data transmitted from the terminal device 10. The service provided by the server device 20 is not limited to the service in sports watching in a stadium, but may be a service provided at places where many people gather, such as cinemas, theaters, amusement parks, stations, and tourist spots.

The configuration of the data collection system 1 illustrated in FIG. 1 is merely an example, and other configurations may be adopted. For example, the data collection system 1 illustrated in FIG. 1 may include plural server devices 20. In this case, for example, when there are many spectators in a stadium or the like and a lot of data is transmitted from the terminal device 10 to the server devices 20, the processing load may be distributed among the server devices 20.

[Outline of Data Collection and GW Determination]

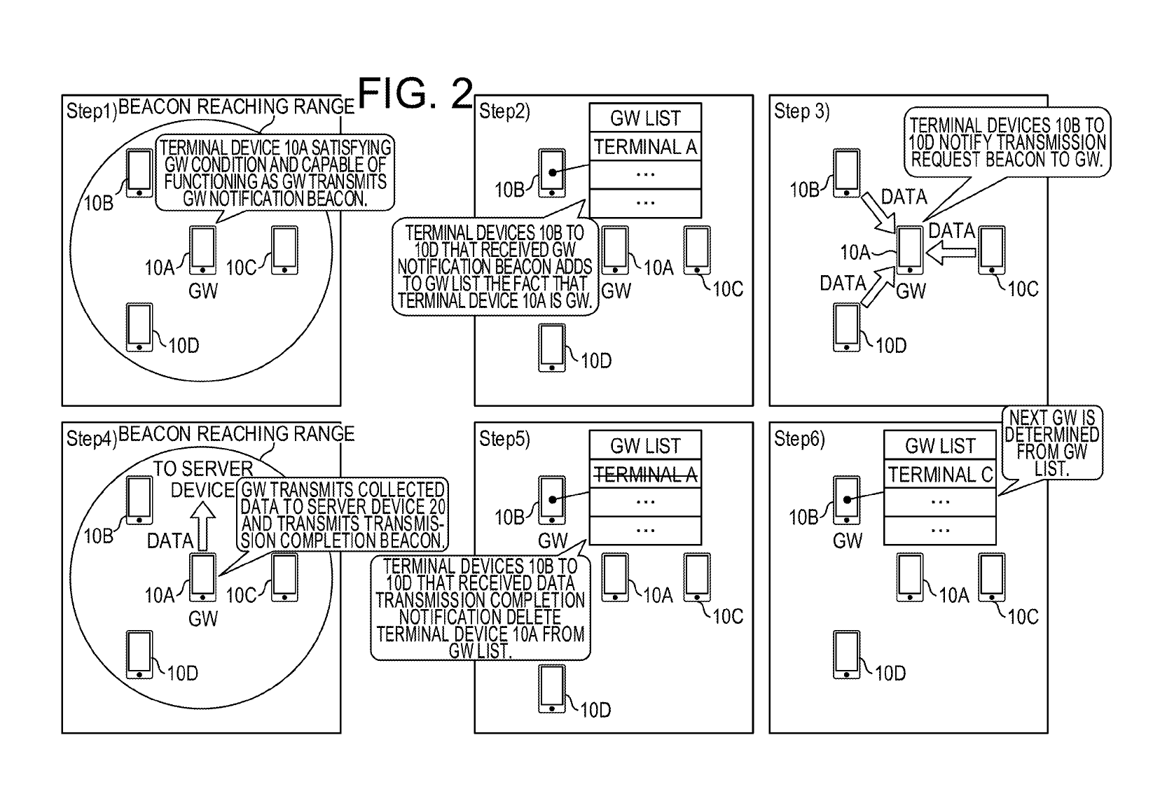

Here, the outline of data collection in the terminal device 10 functioning as GW and determination of the terminal device 10 functioning as GW next will be described with reference to FIG. 2. FIG. 2 is a view for explaining the outline of data collection and GW determination. In FIG. 2, the plural terminal devices 10 are distinguished as a “terminal device 10A,” a “terminal device 10B,” a “terminal device 10C,” and a “terminal device 10D. A case where the terminal device 10A among the plural terminal devices 10 first functions as GW will be described.

Step 1) When the GW condition is satisfied, the data collection processing unit 100 of the terminal device 10A functioning as GW transmits a beacon indicating that the terminal device 10A may function as GW (a GW notification beacon), to the surroundings by, for example, Bluetooth low energy (BLE). Such a beacon may be received by terminal devices 10 that are within a preset beacon reaching range. Hereinafter, it is assumed that the terminal device 10B, the terminal device 10C, and the terminal device 10D are present within the beacon reaching range.

Step 2) Upon receiving the GW notification beacon from the terminal device 10A, the data collection processing unit 100 of the terminal device 10B adds a terminal ID for identifying the terminal device 10A to a GW list. The GW list is a list that stores terminal IDs of terminal devices 10 that satisfy the GW condition and may function as GW (that is, terminal devices 10 that may become GW). For example, the terminal device 10 of a terminal ID stored at the head of the GW list actually functions as GW.

Similarly, upon receiving the GW notification beacon from the terminal device 10A, the data collection processing units 100 of the terminal device 10C and the terminal device 10D add the terminal ID of the terminal device 10A to the GW list.

Step 3) The data collection processing unit 100 of the terminal device 10B transmits a beacon indicating a request for transmission of data to the server device 20 (transmission request beacon), with the terminal ID stored at the head of the GW list (here, the terminal ID of the terminal device 10A) as a reception destination, by BLE or the like. The transmission request beacon includes data transmitted to the server device 2 (e.g., data indicating the number of times of waving of the terminal device 10B). Hereinafter, the data included in the transmission request beacon is also referred to as “transmission target data.”

Similarly, the data collection processing units 100 of the terminal device 10C and the terminal device 10D transmit a transmission request beacon, with the terminal ID stored at the head of the GW list as a reception destination, by BLE or the like.

By receiving the transmission request beacon from each of the terminal devices 10B to 10D, the terminal device 10A may collect transmission target data from each of these terminal devices 10B to 10D.

Step 4) The data collection processing unit 100 of the terminal device 10A transmits the transmission target data collected from each of the terminal devices 10B to 10D to the server device 20 via the network N. That is, the terminal device 10A functions as GW of the terminal devices 10B to 10D.

Then, the data collection processing unit 100 of the terminal device 10A transmits a beacon indicating that the data transmission to the server device 20 is completed (a transmission completion beacon), by BLE or the like.

Step 5) Upon receiving the transmission completion beacon from the terminal device 10A functioning as GW, the data collection processing unit 100 of the terminal device 10B deletes the terminal ID of the terminal device 10A from the GW list.

Similarly, upon receiving the transmission completion beacon from the terminal device 10A, the data collection processing units 100 of the terminal devices 10C and the terminal device 10D delete the terminal ID of the terminal device 10A from the GW list.

Step 6) The data collection processing units 100 of the terminal devices 10A to 10D determine a terminal device 10 that will next function as GW from the GW list. That is, for example, when the terminal ID of the terminal device 10C is stored at the head of the GW list, the terminal device 10C functions as GW. In this case, the data collection processing units 100 of the terminal device 10A, the terminal device 10B, and the terminal device 10D transmit the transmission request beacon, with the terminal device 10 C functioning as GW as a destination.

As described above, in the data collection system 1 according to the present embodiment, each terminal device 10 has the GW list storing the terminal IDs of the terminal devices 10 that may become GW. Then, each terminal device 10 causes the terminal devices 10 of the terminal IDs to function as GW by transmitting the transmission request beacon, with the terminal ID stored at the head of the GW list as a destination. Further, upon receiving the transmission completion beacon, each terminal device 10 deletes the terminal ID of the terminal device 10 as the transmission source of the transmission completion beacon (that is, the terminal device 10 functioning as GW) from the GW list.

As a result, the plural terminal devices 10 capable of becoming GW may be caused to function as GW in order, and load distribution may be performed among the plural terminal devices 10. Further, the data collection or the GW determination is easily performed by performing the GW notification or the notifications of, for example, the transmission request and the transmission completion by a beacon, and load distribution may be efficiently performed among the plural terminal devices 10.

[Hardware Configuration of Terminal Device]

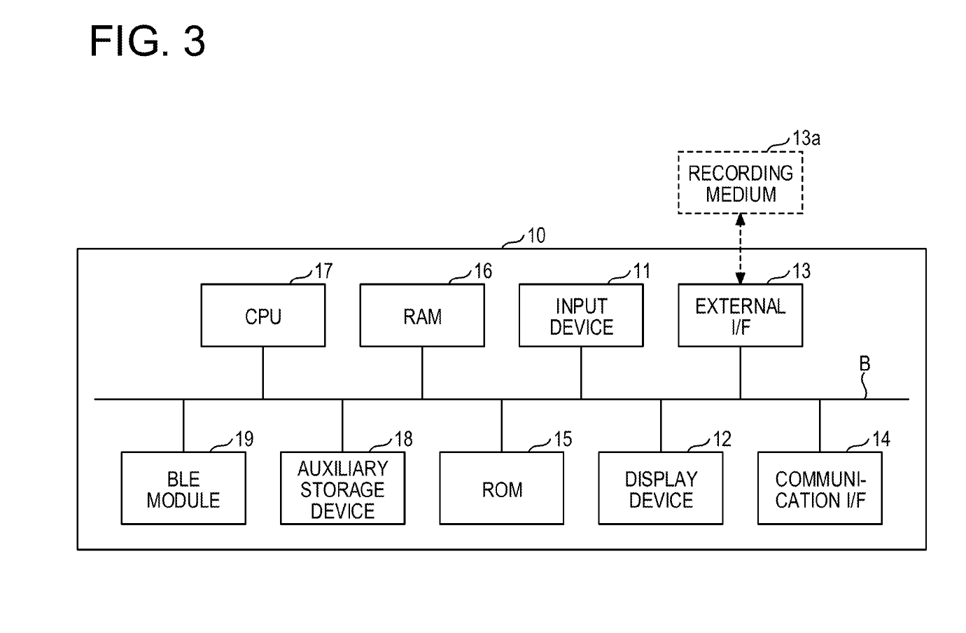

Next, the hardware configuration of a terminal device 10 according to the present embodiment will be described with reference to FIG. 3. FIG. 3 is a view illustrating an example of the hardware configuration of a terminal device 10 according to the present embodiment.

As illustrated in FIG. 3, the terminal device 10 according to the present embodiment includes an input device 11, a display device 12, an external I/F 13, a communication I/F 14, and a read only memory (ROM) 15. Further, the terminal device 10 according to the present embodiment includes a random access memory (RAM) 16, a central processing unit (CPU) 17, an auxiliary storage device 18, and a BLE module 19. These components are interconnected via a bus B.

The input device 11 is, for example, a touch panel, and is used for inputting various operation signals to the terminal device 10. For example, the input device 11 may be a keyboard, a mouse, or various buttons. The display device 12 is, for example, a display and displays various processing results by the terminal device 10.

The external I/F 13 is an interface with an external device. The external device is, for example, a recording medium 13a. The terminal device 10 may read and write the recording medium 13a via the external I/F 13.

The recording medium 13a is, for example, an SD memory card or a USB memory. The recording medium 13a may be, for example, a compact disk (CD) or a digital versatile disk (DVD).

The communication I/F 14 is an interface for connecting the terminal device 10 to the network N. The terminal device 10 may communicate with the server device 20 via the communication I/F 14.

The ROM 15 is a nonvolatile semiconductor memory capable of holding data even when power is turned off. The RAM 16 is a volatile semiconductor memory that temporarily holds programs or data. The CPU 17 is an arithmetic device that reads programs or data from, for example, the auxiliary storage device 18 or the ROM 15 onto the RAM 16 and executes various processes.

The auxiliary storage device 18 is, for example, a flash memory and is a nonvolatile memory that stores programs or data. The programs or data stored in the auxiliary storage device 18 are, for example, an operation system (OS) that is basic software, various applications, and one or more programs that implement the data collection processing unit 100. The BLE module 19 is a module for transmitting a beacon by BLE.

The terminal device 10 may further include, for example, an acceleration sensor for generating data indicating the number of times of waving of the terminal device 10.

The terminal device 10 according to the present embodiment has the hardware configuration illustrated in FIG. 3, so that various processes to be described later are implemented.

[Functional Configuration of Terminal Device]

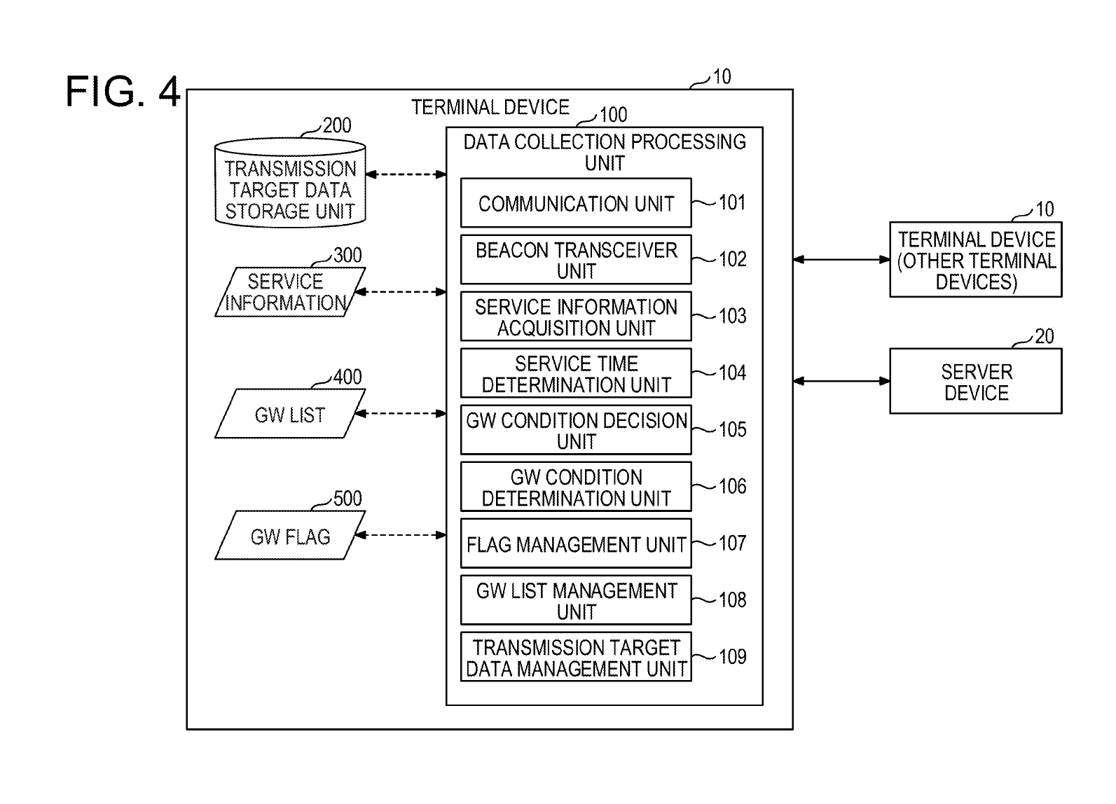

Next, the functional configuration of the terminal device 10 according to the present embodiment will be described with reference to FIG. 4. FIG. 4 is a view illustrating an example of the functional configuration of the terminal device 10 according to the present embodiment.

As illustrated in FIG. 4, the terminal device 10 according to the present embodiment includes the data collection processing unit 100 as described above. The data collection processing unit 100 is implemented when one or more programs installed in the terminal device 10 cause the CPU 17 to execute a process.

The terminal device 10 according to the present embodiment includes a transmission target data storage unit 200, service information 300, a GW list 400, and a GW flag 500. The transmission target data storage unit 200 is implemented by using, for example, the auxiliary storage device 18. The service information 300, the GW list 400, and the GW flag 500 are stored in, for example, the auxiliary storage device 18 or the RAM 16.

The data collection processing unit 100 performs a process related to data collection and a process related to GW determination with other terminal devices 10. The data collection processing unit 100 includes a communication unit 101, a beacon transceiver unit 102, a service information acquisition unit 103, a service time determination unit 104, and a GW condition decision unit 105. Further, the data collection processing unit 100 includes a GW condition determination unit 106, a flag management unit 107, a GW list management unit 108, and a transmission target data management unit 109.

The communication unit 101 communicates with the server device 20 via the network N. That is, the communication unit 101 transmits the transmission target data collected from the other terminal devices 10 to the server device 20. Further, for example, the communication unit 101 receives the service information 300 to be described later from the server device 20.

The beacon transceiver unit 102 receives beacons (a GW notification beacon, a transmission request beacon, and a transmission completion beacon) from other terminal devices 10. In addition, the beacon transceiver unit 102 transmits beacons (a GW notification beacon, a transmission request beacon, and a transmission completion beacon). The beacons are not limited to ones using BLE. The beacons may be ones using, for example, wireless local area network (LAN) or ultra wide band (UWB).

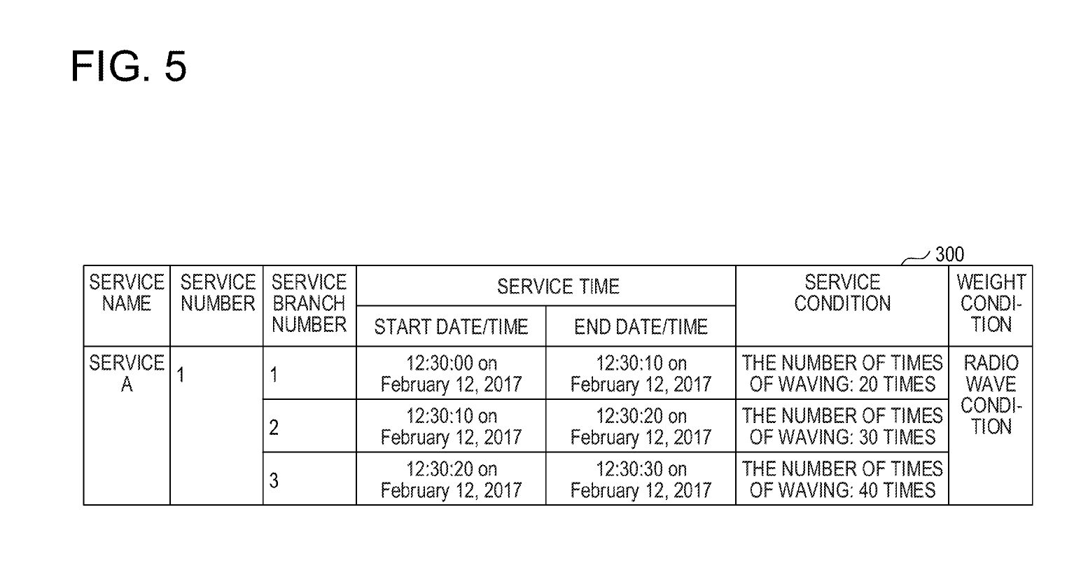

The service information acquisition unit 103 acquires the service information 300 from the server device 20 via the communication unit 101. Here, the service information 300 will be described with reference to FIG. 5. FIG. 5 is a view illustrating an example of the service information 300.

As illustrated in FIG. 5, the service information 300 includes, as data items, a service name, a service number, a service branch number, a service time, a service condition, and a weight condition.

The service name is a name of a service provided by the server device 20. The service number is identification information for identifying the service.

The service branch number is information used when it is desired to change the service condition or the weight condition to be described later within a time for which the service is provided. In the example illustrated in FIG. 5, different service times and service conditions are associated with the service branch numbers “1” to “3.” For example, between “12:30:00 on Feb. 12, 2017” and “12:30:10 on Feb. 12, 2017,” “the number of times of waving: 20 times” is used as the service condition. Similarly, between “12:30:10 on Feb. 12, 2017” and “12:30:20 on Feb. 12, 2017,” “the number of times of waving: 30 times” is used as the service condition. Similarly, between “12:30:20 on Feb. 12, 2017” and “12:30:30 on Feb. 12, 2017,” “the number of times of waving: 40 times” is used as the service condition.

The service time includes a start date/time indicating date/time at which provision of the service is started and an end date/time indicating date/time at which the provision of the service is ended. The service condition and the weight condition are conditions constituting the GW condition. The GW condition is determined, for example, by “service condition×weight condition.”

It is illustrated in FIG. 5 that “the number of times of waving” is used as the service condition, but the present disclosure is not limited thereto. The service condition may be, for example, the number of times of touching of the touch panel of the terminal device 10. The service condition may be completion of a predetermined operation (e.g., an operation of tapping a number of randomly scattered tags on a screen in order from 1 to a predetermined number, or a swipe operation in a predetermined direction).

In addition, in the example illustrated in FIG. 5, “radio wave condition” is used as the weight condition. This is to make a terminal device 10 with a poor radio wave condition difficult to become a GW, for example, by setting a higher weight for the terminal device 10. Meanwhile, this is to make a terminal device 10 with a good radio wave condition easy to become a GW, for example, by setting a lower weight for the terminal device 10.

In addition to the “radio wave condition,” the weight condition may be, for example, “remaining battery capacity,” or “past GW frequency.” For example, the “remaining battery capacity” may be used as the weight condition to make a terminal device 10 with larger remaining battery capacity easy to become a GW, while making a terminal device 10 with smaller remaining battery capacity difficult to become a GW. Further, for example, the “past GW frequency” may be used as the weight condition to make a terminal device 10 that has become a GW in the past a larger number of times difficult to become a GW, while making a terminal device 10 that has become a GW in the past a smaller number of times easy to become a GW.

In this way, the service information 300 is information including the service time indicating the service provision time, and the service condition and the weight conditions which are used within the service time. By referring to the service information 300 acquired from the server device 20, each terminal device 10 may determine whether or not the present time is within the service time. In addition, by referring to the service information 300 acquired from the server device 20, each terminal device 10 may determine the GW condition from the service condition and the weight condition.

The service information 300 of the service name “service A” has been illustrated in FIG. 5. However, the terminal device 10 may acquire the service information 300 of the service name “service B” or the service information of the service name “service C” from the server device 20.

The service time determination unit 104 refers to the service information 300 to determine whether or not the current date/time is within the service time. The GW condition decision unit 105 refers to the service information 300 to determine the GW condition of the terminal device 10. The GW condition determination unit 106 determines whether or not the GW condition decided by the GW condition decision unit 105 is satisfied.

The flag management unit 107 determines whether the GW flag 500 is “true” or “false.” In addition, the flag management unit 107 updates the GW flag 500. The GW flag 500 is information indicating whether or not the terminal device 10 may function as a GW. When it is determined that the GW flag 500 is “true,” it means that the terminal device 10 may function as a GW. Meanwhile, when it is determined that the GW flag 500 is “false,” it means that the terminal device 10 may not function as a GW.

The GW list management unit 108 manages the GW list 400. That is, when the beacon transceiver unit 102 receives a GW notification beacon, the GW list management unit 108 adds a terminal ID included in the GW notification beacon (that is, the terminal ID of the terminal device 10 capable of functioning as a GW) to the GW list 400. When the beacon transceiver unit 102 receives a transmission completion beacon, the GW list management unit 108 deletes a terminal ID included in the transmission completion beacon (that is, the terminal ID of the terminal device 10 capable of actually functioning as a GW) from the GW list 400.

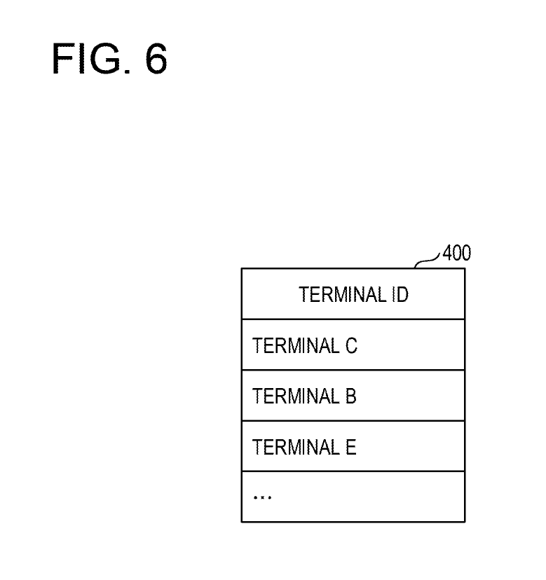

Here, the GW list 400 will be described with reference to FIG. 6. FIG. 6 is a view illustrating an example of the GW list 400.

As illustrated in FIG. 6, the GW list 400 is a list of terminal IDs (e.g., terminal IDs such as “terminal C,” “terminal B,” and “terminal E” for identifying the terminal devices 10 capable of functioning as a GW.

In this manner, the GW list 400 stores the terminal IDs of terminal devices that may function as a GW. Each terminal device 10 may transmit the transmission request beacon, with the terminal ID stored first of the terminal IDs stored in the GW list 400 as a reception destination, so that the terminal device 10 of the terminal ID may function as GW.

The transmission target data management unit 109 manages the transmission target data stored in the transmission target data storage unit 200. That is, when the beacon transceiver unit 102 receives the transmission request beacon, the transmission target data management unit 109 stores the transmission target data included in the transmission request beacon and the terminal ID of the terminal device 10 of the transmission source of the transmission request beacon in association with each other in the transmission target data storage unit 200.

Further, when it is determined that the GW flag 500 is “true,” the transmission target data management unit 109 acquires the transmission target data stored in the transmission target data storage unit 200. The transmission target data acquired by the transmission target data management unit 109 is transmitted to the server device 20 by the communication unit 101.

[Details of Process Performed by Terminal Device]

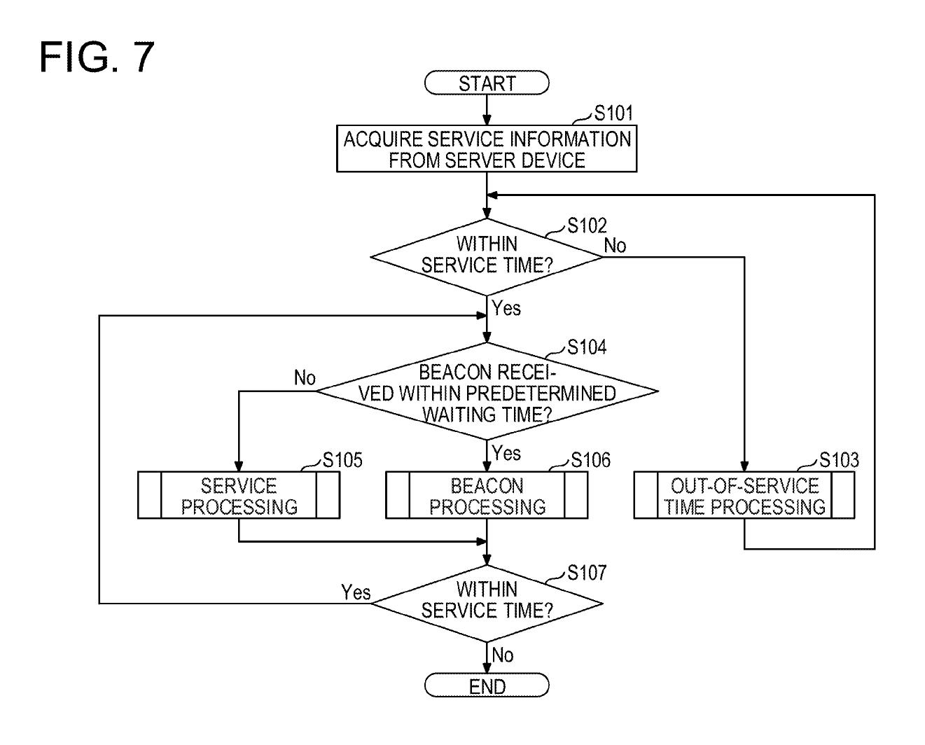

Next, a process executed by a terminal device 10 according to the present embodiment will be described with reference to FIG. 7. FIG. 7 is a flowchart illustrating an example of the overall process by a terminal device according to the present embodiment.

First, the service information acquisition unit 103 acquires the service information 300 from the server device 20 via the communication unit 101 (operation S101). For example, the service information acquisition unit 103 may transmit a request for acquisition of the service information 300 to the server device 20 via the communication unit 101 and acquire the service information 300 in response to the acquisition request.

In addition, for example, the service information acquisition unit 103 may transmit a request for acquisition of the service information 300 of a service name designated by a user to the server device 20 and may acquire the service information 300 of the designated service name from the server device 20.

Next, the service time determination unit 104 refers to the service information 300 acquired by the service information acquisition unit 103 to determine whether or not the current date/time is within the service time (operation S102).

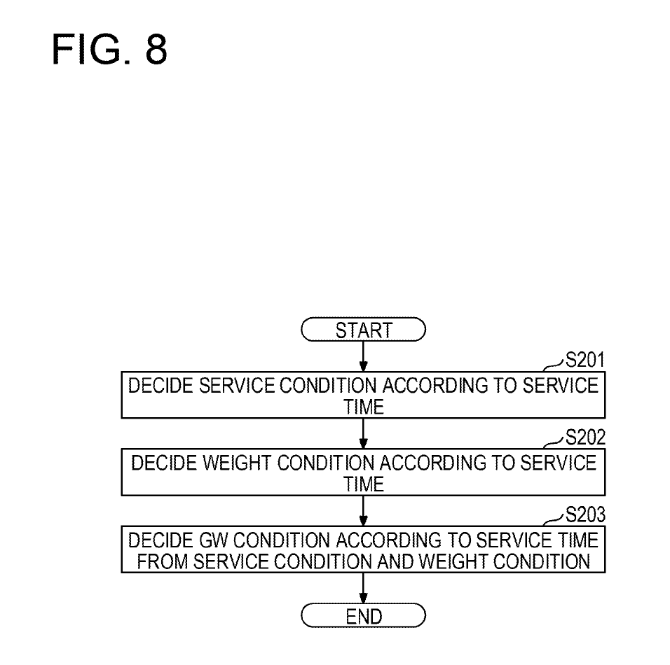

When it is determined in operation S102 that the current date/time is not within the service time, the data collection processing unit 100 executes out-of-service time processing (operation S103). The out-of-service time processing in the operation S103 will be described with reference to FIG. 8. FIG. 8 is a flowchart illustrating an example of the out-of-service time processing according to the present embodiment.

First, the GW condition decision unit 105 refers to the service information 300 to decide a service condition according to the service time (operation S201).

For example, by referring to the service information 300 illustrated in FIG. 5, the GW condition decision unit 105 decides the service condition between “12:30:00 on Feb. 12, 2017” and “12:30:10 on Feb. 12, 2017” as “the number of times of waving: 20 times.” Similarly, for example, the GW condition decision unit 105 decides the service condition between “12:30:10 on Feb. 12, 2017” and “12:30:20 on Feb. 12, 2017” as “the number of times of waving: 30 times.” Similarly, for example, the GW condition decision unit 105 decides the service condition between “12:30:20 on Feb. 12, 2017” and “12:30:30 on Feb. 12, 2017” as “the number of times of waving: 40 times.”

Next, the GW condition decision unit 105 refers to the service information 300 to decide a weighting condition according to the service time (operation S202).

For example, by referring to the service information 300 illustrated in FIG. 5, the GW condition decision unit 105 decides that the weight condition for the time period between “12:30:00 on Feb. 12, 2017” and “12:30:10 on Feb. 12, 2017” is “radio wave condition.” Similarly, for example, the GW condition decision unit 105 decides that the weight condition for the time periods between “12:30:10 on Feb. 12, 2017” and “12:30:20 on Feb. 12, 2017” and between “12:30:20 on Feb. 12, 2017” and “12:30:30 on Feb. 12, 2017” is “radio wave condition.”

Next, the GW condition decision unit 105 decides a GW condition according to the service time from the service condition and the weight condition decided in the operations S201 and S202, respectively (operation S203).

For example, the GW condition decision unit 105 decides that the GW condition for the time period between “12:30:00 on Feb. 12, 2017” and “12:30:10 on Feb. 12, 2017” is “20 times×w₁.” This indicates that the GW condition is satisfied when a user waves the terminal device 10 “20×w₁” times. Here, for example, w₁ is a weight calculated from the radio wave condition of the terminal device 10 at each time point between “12:30:00 on Feb. 12, 2017” and “12:30:10 on Feb. 12, 2017.” For example, w₁ is a value between 0 and 1 and is decided according to the communication speed by the communication unit 101.

Similarly, for example, the GW condition decision unit 105 decides that the GW condition for the time period between “12:30:10 on Feb. 12, 2017” and “12:30:20 on Feb. 12, 2017” is “30 times×w₂.” This indicates that the GW condition is satisfied when the user waves the terminal device 10 “30×w₂” times. Here, for example, w₂ is a weight calculated from the radio wave condition of the terminal device 10 at each time point between “12:30:10 on Feb. 12, 2017” and “12:30:20 on Feb. 12, 2017.” For example, w₂ is a value between 0 and 1 and is decided according to the communication speed by the communication unit 101.

Similarly, for example, the GW condition decision unit 105 decides that the GW condition for the time period between “12:30:20 on Feb. 12, 2017” and “12:30:30 on Feb. 12, 2017” is “40 times×w₃.” This indicates that the GW condition is satisfied when the user waves the terminal device 10 “40×w₃” times. Here, for example, w₃ is a weight calculated from the radio wave condition of the terminal device 10 at each time point between “12:30:20 on Feb. 12, 2017” and “12:30:30 on Feb. 12, 2017.” For example, w₃ is a value between 0 and 1 and is decided according to the communication speed by the communication unit 101.

In the above description, w₁, w₂, and w₃ are calculated based on the radio wave condition at each point of the service time, but the present disclosure is not limited thereto. For example, w₁, w₂, and w₃ may be calculated based on the radio wave condition one hour before the start date/time included in the service time. Specifically, for example, w₁, w₂, and w₃ may be calculated according to the average of the communication speeds one hour before the start date/time.

In addition, w₁, w₂, and w₃ may be not only determined according to the communication speed by the communication unit 101 but also may be determined depending on whether or not the terminal device 10 is connected to, for example, Wi-Fi.

Referring back to FIG. 7, when it is determined in operation S102 that the current date/time is within the service time, the beacon transceiver unit 102 determines whether or not a beacon has been received from another terminal device 10 within a predetermined waiting time (operation S104). That is, when it is determined in operation S102 that the current date/time is within the service time, the terminal device 10 waits for a preset predetermined time. Then, the beacon transceiver unit 102 of the terminal device 10 determines whether or not a beacon has been received from another terminal device 10 while waiting.

When it is determined in operation S104 that a beacon has not been received from another terminal device 10, the data collection processing unit 100 executes service processing (operation S105).

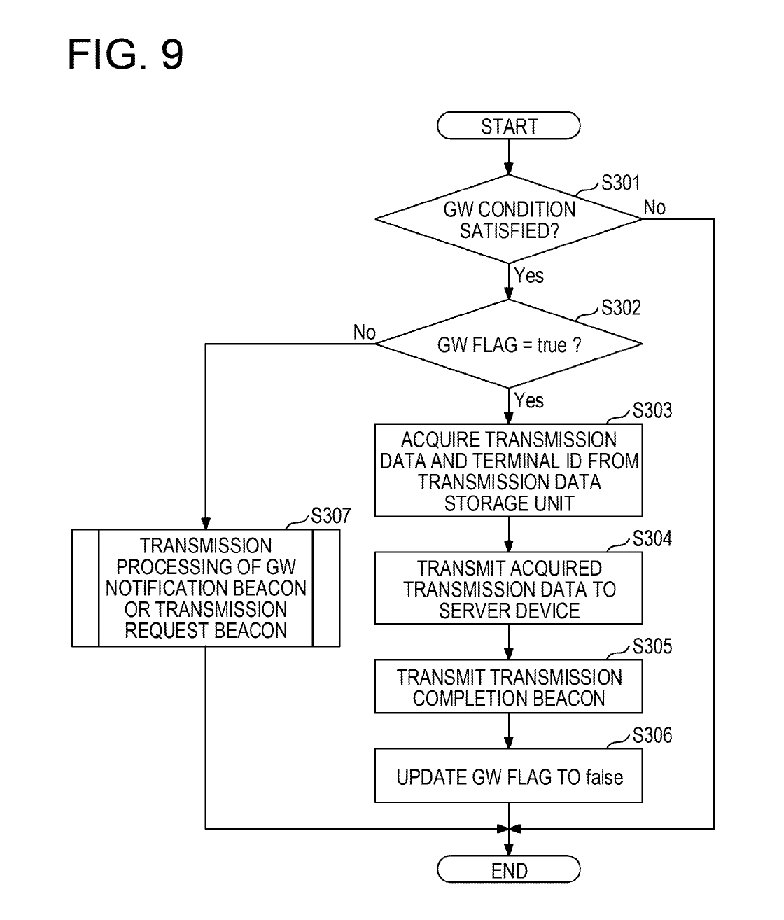

Here, the service processing in operation S105 will be described with reference to FIG. 9. FIG. 9 is a flowchart illustrating an example of service processing according to the present embodiment.

First, the GW condition determination unit 106 determines whether or not the GW condition decided by the GW condition decision unit 105 is satisfied (operation S301). For example, when the GW condition is “20 times×w₁” or w₁=0.5, the GW condition determination unit 106 determines whether or not the number of times of waving of the terminal device 10 by the user is 10 or more. The number of times of waving of the terminal device 10 by the user is measured by, for example, an acceleration sensor, and data indicating the measurement result is stored in a predetermined storage area.

When it is determined in operation S301 that the GW condition is not satisfied, the data collection processing unit 100 ends the service processing.

Meanwhile, when it is determined in operation S301 that the GW condition is satisfied, the flag management unit 107 determines whether or not the GW flag 500 is “true” (operation S302). This means that it is determined whether or not the terminal device 10 may function as a GW.

When it is determined in operation S302 that the GW flag 500 is “true,” the transmission target data management unit 109 acquires the transmission target data stored in the transmission target data storage unit 200, and a terminal ID (operation S303). That is, when the terminal device 10 is capable of functioning as a GW, the transmission target data management unit 109 acquires the transmission target data stored in the transmission target data storage unit 200 and a terminal ID associated with the transmission target data. In the transmission target data storage unit 200, transmission target data included in transmission request beacons received from the other terminal devices 10 and terminal IDs of the terminal devices 10 as the transmission sources of the transmission request beacons are stored in association with each other.

The transmission target data management unit 109 may compile the transmission target data acquired from the transmission target data storage unit 200 into one data and perform data compression on the one data. By performing the data compression, it is possible to reduce the amount of data to be transmitted to the server device 20.

Next, the communication unit 101 transmits the transmission target data acquired by the transmission target data management unit 109 (or data obtained by compressing the transmission target data) to the server device 20 (operation S304). As a result, the transmission target data collected from the other terminal devices 10 are transmitted to the server device 20 and stored in the server device 20.

Next, the beacon transceiver unit 102 transmits a transmission completion beacon (operation S305). The transmission completion beacon includes the terminal ID of the terminal device 10 functioning as a GW and the terminal ID acquired from the transmission target data storage unit 200 in the above operation S303. As a result, as will be described later, the other terminal devices 10 that have received the transmission completion beacon may determine whether or not their own transmission target data have been transmitted to the server device 20. Further, as will be described later, the other terminal devices 10 that have received the transmission completion beacon may delete the terminal ID of the terminal device 10 functioning as a GW from the GW list 400.

Next, the flag management unit 107 updates the GW flag 500 to “false” (operation S306). By updating the GW flag 500 to “false,” the terminal device 10 does not function as a GW. Thus, for example, it is possible to prevent situations in which one terminal device 10 continuously functions as a GW, and achieve effective load distribution.

When it is determined in operation S302 that the GW flag 500 is “false,” the data collection processing unit 100 executes transmission processing of the GW notification beacon or the transmission request beacon (operation S307). In the transmission processing of the GW notification beacon or the transmission request beacon, the GW notification beacon or the transmission request beacon is transmitted depending on whether or not a terminal ID is included in the GW list 400. That is, when a terminal ID is included in the GW list 400, the terminal device 10 of the terminal ID is set as a GW and transmits the transmission request beacon. Meanwhile, when a terminal ID is not included in the GW list 400, it becomes itself GW. Details of the transmission processing of the GW notification beacon or the transmission request beacon will be described later.

Referring back to FIG. 7, when it is determined in operation S104 that a beacon has been received from another terminal device 10, the data collection processing unit 100 executes beacon processing (operation S106).

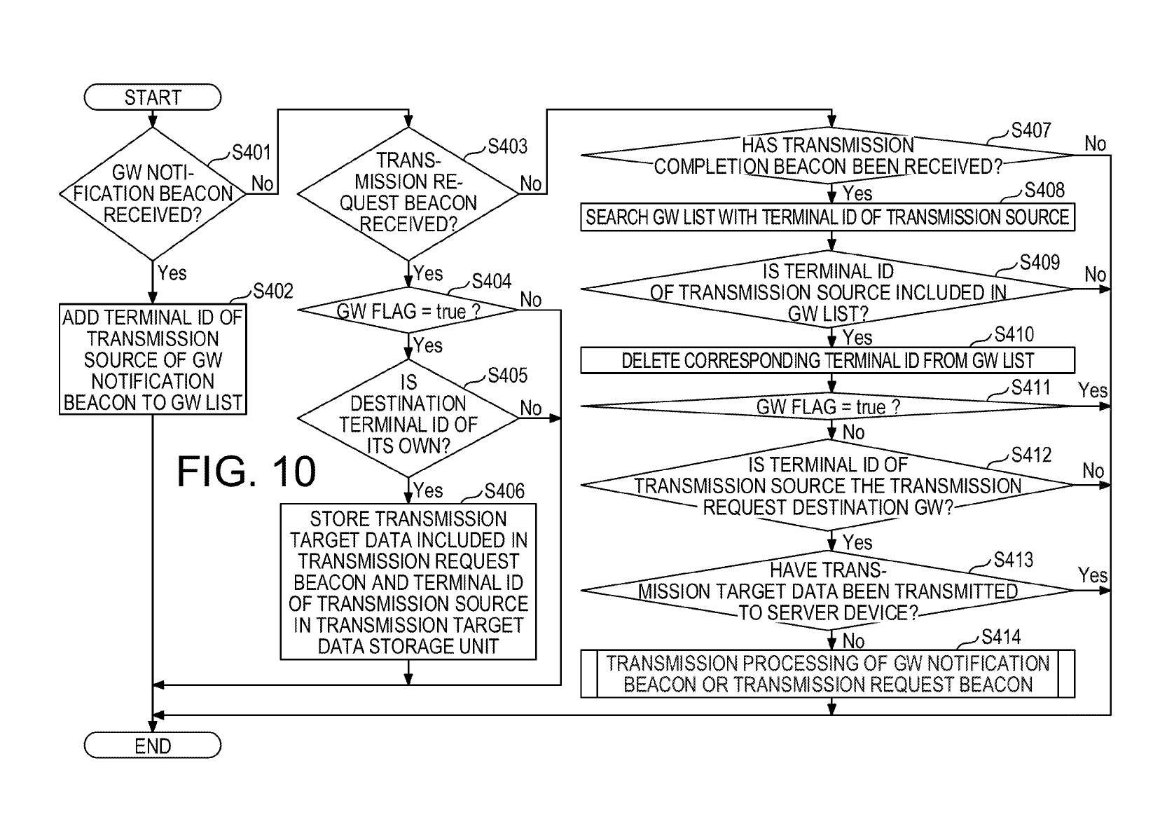

Here, the beacon processing in operation S106 will be described with reference to FIG. 10. FIG. 10 is a flowchart illustrating an example of beacon processing according to the present embodiment.

First, the beacon transceiver unit 102 determines whether or not a GW notification beacon has been received (operation S401).

When it is determined in operation S401 that the GW notification beacon has been received, the GW list management unit 108 adds the terminal ID of a terminal device 10 as the transmission source of the GW notification beacon received by the beacon transceiver unit 102 to the GW list 400 (operation S402). At this time, the GW list management unit 108 may add the terminal ID to the rearmost of the GW list.

After receiving the GW notification beacon in the above operation S402, the terminal device 10 may transmit a transmission request beacon addressed to the terminal device 10 as the transmission source of the GW notification beacon. That is, the terminal device 10 may perform operation S502 to be described later after performing the above operation S402. As a result, the terminal device 10 may transmit the current data (for example, data indicating the number of times of waving at the present point of time) to the server device 20. However, in this case, even when the terminal device 10 receives the GW notification beacon from another terminal device 10, the terminal device 10 does not transmit a transmission request beacon addressed to the another terminal device 10 until a transmission completion beacon is received from the terminal device 10 as the transmission source of the GW notification beacon. This is to prevent a situation in which duplicate data are transmitted to the server device 20.

Meanwhile, when it is determined in operation S401 that the GW notification beacon has not been received, the beacon transceiver unit 102 determines whether or not a transmission request beacon has been received (operation S403).

When it is determined in operation S403 that the transmission request beacon has been received, the flag management unit 107 determines whether or not the GW flag 500 is “true” (operation S404).

When it is determined in operation S404 that the GW flag 500 is “false,” the data collection processing unit 100 ends the beacon processing. This is the case where a terminal device 10, which is not a GW, receives the transmission request beacon.

Meanwhile, when it is determined in operation S404 that the GW flag 500 is “true,” the beacon transceiver unit 102 determines whether or not the destination of the transmission request beacon is the terminal ID of its own (operation S405).

When it is determined in operation S405 that the destination of the transmission request beacon is not the terminal ID of its own, the data collection processing unit 100 ends the beacon processing. This is the case when a transmission request beacon addressed to another GW (that is, another terminal device 10 functioning as a GW) is received.

Meanwhile, when it is determined in operation S405 that the destination of the transmission request beacon is the terminal ID of its own, the transmission target data management unit 109 stores the transmission target data included in the transmission request beacon in the transmission target data storage unit 200 (operation S406). At this time, the transmission target data management unit 109 stores the terminal ID of the terminal device 10 of the transmission source of the transmission request beacon in the transmission target data storage unit 200 in association with the transmission target data.

When it is determined in operation S403 that the transmission request beacon has not been received, the beacon transceiver unit 102 determines whether or not a transmission completion beacon has been received (operation S407).

When it is determined in operation S407 that the transmission completion beacon has not been received, the data collection processing unit 100 ends the beacon processing. This is the case when a beacon that is neither a GW notification beacon, a transmission request beacon, nor a transmission completion beacon is received.

Meanwhile, when it is determined in operation S407 that the transmission completion beacon has been received, the GW list management unit 108 searches the GW list 400 with the terminal ID of the terminal device 10 as the transmission source of the transmission completion beacon (operation S408). That is, the GW list management unit 108 searches the GW list 400 using the terminal ID as a search key.

Next, the GW list management unit 108 determines whether or not the terminal ID is included in the GW list 400 as a result of the search in the above operation S408 (operation S409).

When it is determined in operation S409 that the terminal ID of the terminal device 10 as the transmission source of the transmission completion beacon is not included in the GW list 400, the data collection processing unit 100 ends the beacon processing. This is the case when a transmission completion beacon is received from the terminal device 10 of a terminal ID not included in the GW list 400.

Meanwhile, when it is determined in operation S409 that the terminal ID of the terminal device 10 as the transmission source of the transmission completion beacon is included in the GW list 400, the GW list management unit 108 deletes the terminal ID from the GW list 400 (operation S410). As a result, the terminal device 10 that is the GW at the present point of time does not become a GW until it again transmits the GW notification beacon.

Next, the flag management unit 107 determines whether or not the GW flag 500 is “true” (operation S411).

When it is determined in operation S411 that the GW flag 500 is “true,” the data collection processing unit 100 ends the beacon processing. This is the case when it is itself GW.

Meanwhile, when it is determined in operation S411 that the GW flag 500 is “false,” the beacon transceiver unit 102 determines whether or not the terminal ID of the terminal device 10 as the transmission source of the transmission completion beacon is the terminal ID of a GW to which the transmission request beacon is addressed (operation S412). In other words, the beacon transceiver unit 102 determines whether or not the transmission request beacon has been transmitted, with the terminal ID of the terminal device 10 as the transmission source of the transmission completion beacon as a destination.

When it is determined in operation S412 that the terminal ID of the terminal device 10 as the transmission source of the transmission completion beacon is not the terminal ID of the GW, the data collection processing unit 100 ends the beacon processing. This is the case where a transmission completion beacon is received from a GW that makes no transmission request.

Meanwhile, when it is determined in operation S412 that the terminal ID of the terminal device 10 as the transmission source of the transmission completion beacon is the terminal ID of the GW, the beacon transceiver unit 102 determines whether or not the transmission target data of its own has been transmitted to the server device 20 (operation S413). That is, the beacon transceiver unit 102 determines whether or not the terminal ID of its own is included in the transmission completion beacon.

When it is determined in operation S413 that the terminal ID of its own is included in the transmission completion beacon, the data collection processing unit 100 ends the beacon processing. This is the case where the transmission target data of its own is transmitted to the server device 20.

Meanwhile, when it is determined in operation S413 that the terminal ID of its own is not included in the transmission completion beacon, the data collection processing unit executes transmission processing of a GW notification beacon or a transmission request beacon (operation S414). In the transmission processing of the GW notification beacon or the transmission request beacon, the GW notification beacon or the transmission request beacon is transmitted depending on whether or not a terminal ID is included in the GW list 400. That is, when a terminal ID is included in the GW list 400, the terminal device 10 of the terminal ID is set as a GW and the transmission request beacon is transmitted. Meanwhile, when a terminal ID is not included in the GW list 400, it becomes itself GW. Details of the transmission processing of the GW notification beacon or the transmission request beacon will be described later.

Referring back to FIG. 7, subsequent to operation S105 or operation S106, the service time determination unit 104 refers to the service information 300 acquired by the service information acquisition unit 103 to determine whether or not the current date/time is within the service time (operation S107).

When it is determined in operation S107 that the current date/time is within the service time, the data collection processing unit 100 returns to operation S104. That is, the data collection processing unit 100 repeats operation S104 to operation S107 while the current date/time is within the service time.

Meanwhile, when it is determined in operation S107 that the current date/time is not within the service time, the data collection processing unit 100 ends the processing.

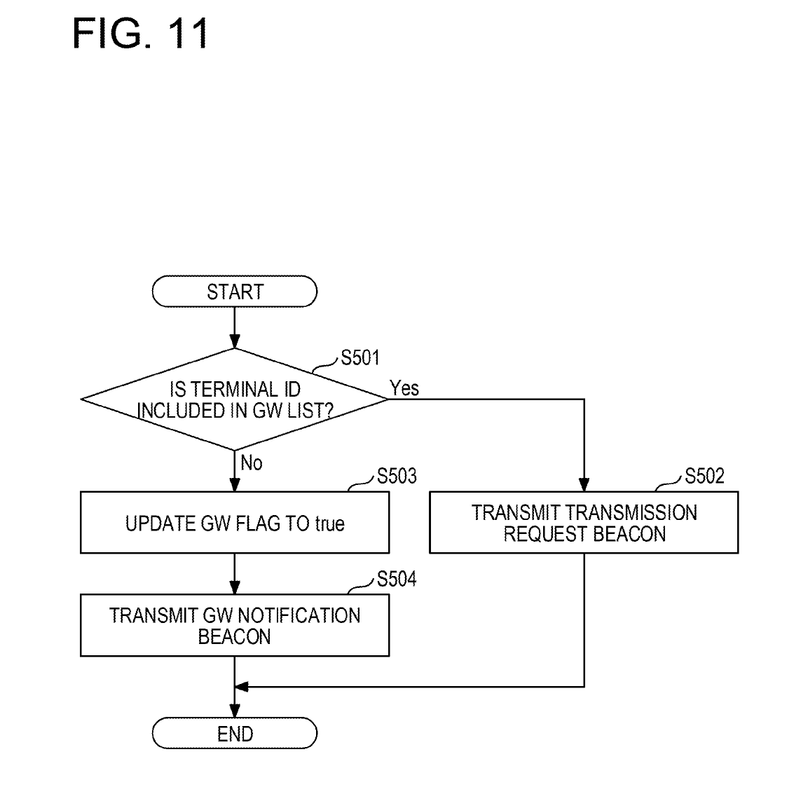

Here, the transmission processing of the GW notification beacon or the transmission request beacon in operation S307 of FIG. 9 and operation S414 of FIG. 10 will be described with reference to FIG. 11. FIG. 11 is a flowchart illustrating an example of transmission processing of the GW notification beacon or the transmission request beacon according to the present embodiment.

First, the GW list management unit 108 determines whether or not a terminal ID is included in the GW list 400 (operation S501). That is, the GW list management unit 108 determines whether or not the GW list 400 is empty.

When it is determined in operation S501 that the GW list 400 is not empty (that is, a terminal ID is included in the GW list 400), the beacon transceiver unit 102 transmits a transmission request beacon (operation S502). At this time, for example, the beacon transceiver unit 102 may transmit the transmission request beacon with the terminal ID stored at the head of the terminal IDs included in the GW list 400 as a destination. However, the present disclosure is not limited thereto. For example, the transmission request beacon may be transmitted with a terminal ID randomly selected from the terminal IDs included in the GW list 400 as a destination.

Meanwhile, when it is determined in operation S401 that the GW list 400 is empty (that is, a terminal ID is included in the GW list 400), the flag management unit 107 updates the GW flag to “true” (operation S503). This means that it will become itself GW.

Next, the beacon transceiver unit 102 transmits a GW notification beacon (operation S504). Thus, it is possible to notify other surrounding terminal devices 10 that it will become itself GW.

As described above, in the data collection system 1 according to the present embodiment, among the plural terminal devices 10, a terminal device 10 that has become a GW transmits the transmission target data collected from other terminal devices 10 to the server device 20. At this time, in the data collection system 1 according to the present embodiment, notification or the like of the terminal device 10 that has become a GW is performed between the plural terminal devices 10 by a beacon using BLE or the like. As a result, it is possible to efficiently perform load distribution among the plural terminal devices 10.

Although the exemplary embodiments of the present disclosure has been described in detail above, the present disclosure is not limited to such specific embodiments, but various modifications and alterations may be made without departing from the spirit and scope of the present disclosure set forth in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device that is a first information processing device, the information processing device comprising:
a memory; and
a processor coupled to the memory and the processor configured to:
transmit, to a second information processing device, a first beacon for indicating that the first information processing device operates as a gateway;
receive a second beacon for requesting that the first information processing device transmits data included in the second beacon to a server; and
transmit, to the server, the data included in the second beacon and a source identification of the second beacon.

2. The information processing device according to claim 1,
wherein the processor is configured to transmit, to the second information processing device, the first beacon when the first information processing device satisfies a specific condition and a gateway list in which a device identification of the second information processing device satisfying the specific condition is stored is empty.

3. The information processing device according to claim 2,
wherein the processor is further configured to:
store the device identification of the second information processing device in the gateway list when the first information processing device receives the first beacon from the second information processing device; and
delete the device identification of the second information processing device from the gateway list when the first information processing device receives, from the second information processing device, a third beacon for indicating that the second information processing device has transmitted the data to the server.

4. The information processing device according to claim 2,
wherein the specific condition indicates a number of times of waving the information processing device.

5. An information processing system comprising:
a plurality of information processing devices configured to include at least a first information processing device and a second information processing device; and
a server configured to couple to any one of the plurality of information processing devices,
wherein the first information processing device includes:
a memory; and
a processor coupled to the memory and the processor configured to:
transmit, to a second information processing device, a first beacon for indicating that the first information processing device operates as a gateway;
receive a second beacon for requesting that the first information processing device transmits data included in the second beacon to a server; and
transmit, to the server, the data included in the second beacon and a source identification of the second beacon.

6. The information processing system according to claim 5,
wherein the processor is configured to transmit, to the second information processing device, the first beacon when the first information processing device satisfies a specific condition and a gateway list in which a device identification of the second information processing device satisfying the specific condition is stored is empty.

7. The information processing system according to claim 6,
wherein the processor is further configured to:
store the device identification of the second information processing device in the gateway list when the first information processing device receives the first beacon from the second information processing device; and
delete the device identification of the second information processing device from the gateway list when the first information processing device receives, from the second information processing device, a third beacon for indicating that the second information processing device has transmitted the data to the server.

8. The information processing system according to claim 6,
wherein the specific condition indicates a number of times of waving the information processing device.

9. An information processing method of an information processing device that is a first information processing device, the information processing method comprising:
transmitting, to a second information processing device, a first beacon for indicating that the first information processing device operates as a gateway;
receiving a second beacon for requesting that the first information processing device transmits data included in the second beacon to a server; and
transmitting, to the server, the data included in the second beacon and a source identification of the second beacon, by a processor.

10. The information processing method according to claim 9,
wherein the processor transmits, to the second information processing device, the first beacon when the first information processing device satisfies a specific condition and a gateway list in which a device identification of the second information processing device satisfying the specific condition is stored is empty.

11. The information processing method according to claim 10,
wherein the processor:
stores the device identification of the second information processing device in the gateway list when the first information processing device receives the first beacon from the second information processing device; and
deletes the device identification of the second information processing device from the gateway list when the first information processing device receives, from the second information processing device, a third beacon for indicating that the second information processing device has transmitted the data to the server.

12. The information processing method according to claim 10,
wherein the specific condition indicates a number of times of waving the information processing device.
